(19) United States
(12) Patent Application Publication
(10) Pub. No.: US 2005/0038815 A1
(43) Pub. Date: Feb. 17, 2005

(54) Real-estate agent verification system and method

(76) Inventors: Majid Ali Syed, Princeton, NJ (US); Masoud Qurashi, Occean Twp., NJ (US)

Correspondence Address: MAJID ALI SYED, 97 YORK DRIVE, PRINCETON, NJ, 08540, US

(21) Appl. No.: 10/640,950

(22) Filed: Aug. 15, 2003

(51) Int. Cl. G06F 7/00

(52) U.S. Cl. 707/104.1

(57) ABSTRACT

Real Estate properties for sell show are vulnerable to misuse, especially if key is placed in a mechanical lock box. System and method is proposed to validate the caller as being a real estate sales associate. The proposed system is always updated with active agent's roster identities. Some scenarios of updates are: when real-estate commission issues a license, when a licensee joins a broker office, and when a licensee changes sub-broker office, when he becomes a referral source or if his license is suspended, revoked. Methods are discussed in which access is made available to an agent sitting in the broker allocated call centers. When a caller calls, to the broker (sub-broker) call center for inquiring about sell show, the proposed system from the calling number identification data makes a search in the agent roster repository. Actions are taken based on yah nay. If yah, combination lock info is provided, if nay, call is either declined for the combination info or more information is taken to validate the caller. An incoming call to a sub broker office can now be traced, verified and logged. We present centralized and distributed processing schemes for article of manufacture.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

The present invention is related to systems and methods for verifying real estate agent.

2. Prior Art

None. At present, when a sales associate calls a realtor office for a listing inquiry, the listing status is provided. If the property is “Available”, sales associate info (mostly his name, agency and office number) is recorded and listing Combination Lock info is provided. This method posses a serious security threat to the owner whose property is being inquired. The answering party in the office has no way of verifying if the caller is a real-estate agent. Therefore, providing lock combination information is subject to vulnerable use.

### BRIEF DESCRIPTION OF THE DRAWINGS

FIG. 1 is end-to-end System Architecture to Verify Calling Person as a REAL-ESTATE Agent.

FIG. 2 is a high level pseudo Procedure to Verify Calling Person is a REAL-ESTATE Sales Agent.

FIG. 3: High Level Message Flow between Sub-Broker Call Attendant and Outside Caller.

### DESCRIPTION OF THE PREFERRED EMBODIMENT

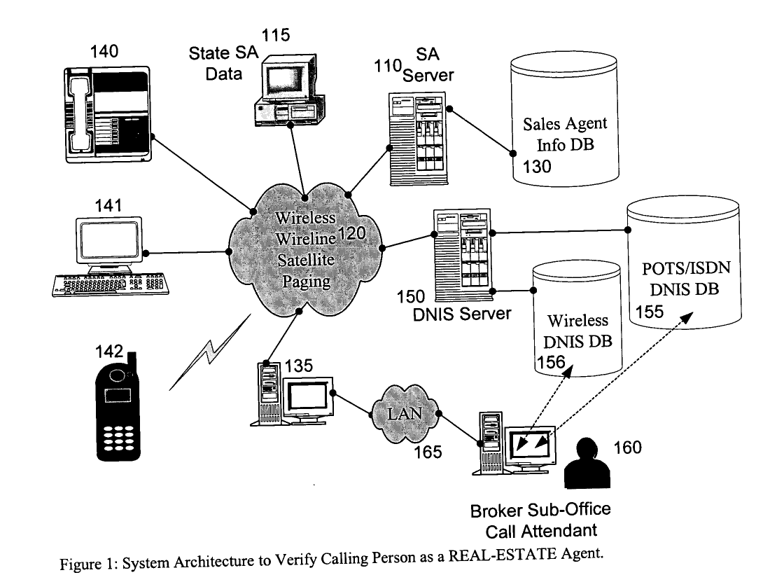

In FIG. 1, Sale Agent Server 110 communicates with State Licensed Sales Agent Data 115 (client first) over a public network 120 at scheduled intervals and updates sales agent data repository 130. Also, state agent office (client first) 115 can poll the sale agent server 110, whenever a new licensee record is created. The broker office 135 (client second), polls sale agent server 110, whenever a new licensee sales agent record is added. The sale agent server 110 at scheduled intervals uploads the each sub-broker office (client third) 160 and creates a mirror map of data repository 130. An incoming call to a sub broker office can now be traced, verified and logged as discussed below.

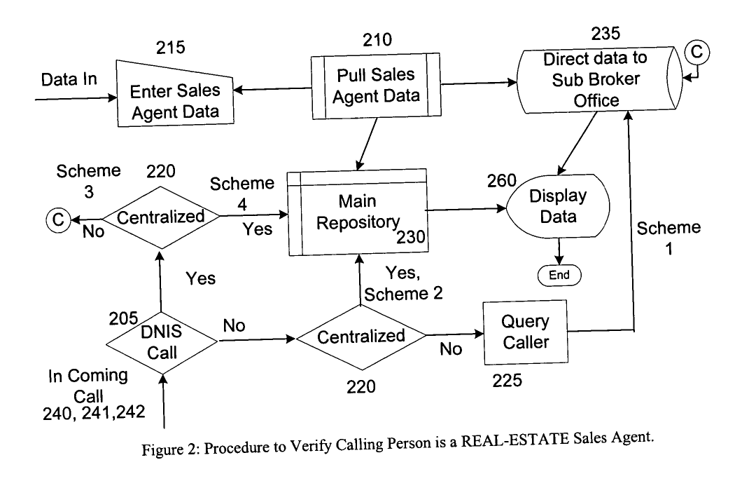

In FIG. 2, when an incoming call 240, 241, 242 is terminated at sub broker office (160 or 165 of FIG. 1), following schemes may be used to verify the caller:

Scheme 1:

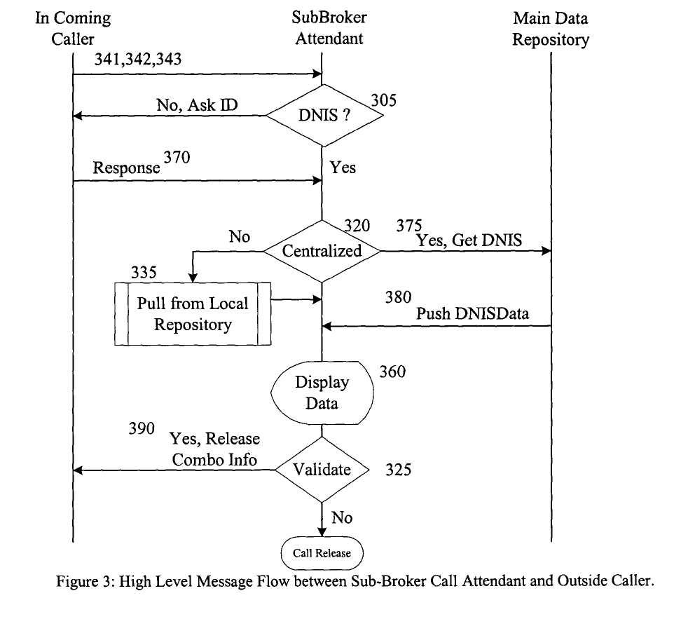

If the sub-broker office (135, 160 of FIG. 1) has caller ID service activated 205 and the proposed client software is configured for mode DECENTRALIZED 220, then the software searches local sub-broker repository 235 which has been pre downloaded by the remote server 110 of FIG. 1. The algorithm matches caller Dialed Number Information Service 305 (as retrieved from 340, 341, 342 of FIG. 3) with the stored data and displays its result to 260 (or 360 of FIG. 3). The call attendant therefore verifies caller data with pre-stored authentic data 335 of FIG. 3.

This is a distributed processing approach and allows the benefit of high up time reliability with a trade off of being data consistency maintenance.

Scheme 2:

If the sub-broker office (135, 160 of FIG. 1) has caller ID service activated 205 and the proposed client software is configured for mode CENTRALIZED 220, the sub broker local computer 235 forwards this information to the network server 110, which replies back with sales agent information if tallied. This is interaction is shown in FIG. 3. This is a centralized processing approach and has a benefit of cost, up time and maintenance with a trade off being slow response to caller.

Scheme 3:

If the sub-broker office (135, 160 of FIG. 1) has caller ID service NOT activated 205 and the proposed client software is configured for mode DECENTRALIZED 220, the call attendant queries the caller of its assigned ID. The call attendant then enters the information to local sub broker office computer, which searches its local repository (prior pre downloaded by network server of 110 of FIG. 1) and shows matched result. This caller data is interrogated and compared with the pre-stored data. The difference between scheme 1 and 3 is that in scheme 1 the call attendant does not need to inquire who is calling. This information is asked only if the caller has unlisted number.

Scheme 4:

If the sub-broker office (135, 160 of FIG. 1) has caller ID service NOT activated 205 and the proposed client software is configured for mode CENTRALIZED 220, the call attendant queries the caller of its assigned ID, passes the information to network server which response back with its result. This caller data is interrogated and compared with the pre-stored data.

FIG. 3 details above schemes in message flow with respect to time. An incoming call 341,342, 340, terminates on a sub-broker system. If the sub broker has taken dialed information service 305 and mode is decentralized 320, the algorithm compares caller information with the pre downloaded data 335 and displays the result 360. The data is validated 325 via interactive query with the caller and if authenticated, combination lock info 390 is provided. If the mode is centralized, get DNIS message 375 is sent to main data repository over public network. The response is Push DNIS data 380, which then gets displayed at 360. Validation process as said earlier is initiated.

If the sub broker has not taken dialed information service 305, then upon call termination, the attendant queries the caller of its assigned ID. This information is then entered in the local repository. Caller validation for centralized or decentralized mode follows steps as said earlier.

1. A central repository maintaining real-estate agent data, said real-estate agent data is accessible to a sub-broker office (client first) upon demand by the sub-broker over a communication link and or said data is pre downloaded in said sub-broker local office repository.

2. A procedure to verify that the calling person is a real-estate agent by inquiring his access identification, comparing said identification with said data 1, either:
a. Pulling the information from the local sub-broker office repository.
b. Pulling the information over network from main repository server.

3. A procedure to verify that the calling person is a real-estate agent by extracting his caller identification, comparing said identification with said data 1, either:
a. Pulling the information from the local sub-broker office repository.
b. Pulling the information over network from main repository server.
